(19) United States
(12) Patent Application Publication
(10) Pub. No.: US 2004/0238804 A1
(43) Pub. Date: Dec. 2, 2004

(54) Merchandise hoisting system and method

(76) Inventor: Frank C. Revi, San Francisco, CA (US)

Correspondence Address: Lawrence D. Graham, Esq., BLACK LOWE & GRAHAM PLLC, 816 Second Avenue, Seattle, WA, 98104, US

(21) Appl. No.: 10/452,684

(22) Filed: May 30, 2003

(51) Int. Cl. B66D 1/26

(52) U.S. Cl. 254/278

(57) ABSTRACT

A garment hoisting system is suspended from overhead in order to avoid using the existing floor area of a merchandise preparation area. Motorized rigging apparatus, associated attachment hardware, and arrangements of rods or pipe, are mounted to overhead building structure and used to lift and lower merchandise safely into and out of the available space above the floor. Control is provided by wired or wireless devices with appropriate buttons for moving the pipes up and down.

### FIELD OF THE INVENTION

This invention generally relates to systems for preparing and storing merchandise, especially garments, in department stores and similar facilities where merchandise is unloaded from delivery trucks and prepared for deployment, especially presentation on a retail sales floor.

### BACKGROUND OF THE INVENTION

High-volume retail stores require much merchandise to be replenished onto their sales floors on a daily basis. Much of this merchandise consists of garments. This merchandise is delivered by truck to the loading dock of the store. The merchandise, which is packed for shipping in boxes, is unloaded from the trucks, unpacked, and prepared for deployment on the sales floor. This process is performed, by people, in a utility area of the store which is provided for this purpose—the Merchandise Preparation Area (MPA). Much of the process consists of unpacking garments from boxes, removing the protective plastic wrappers, sorting the garments according to their specific destination within the retail area of the store, and hanging them on rolling racks in final preparation for deployment. Deployment onto the sales floor happens after business hours, and the prepared merchandise must remain temporarily stored in the MPA until then. The space required for this temporary storage limits the total merchandise capacity of the MPA, and further creates operational inefficiency because as the MPA gets filled with prepared merchandise, less space is available for the ongoing preparation of more merchandise, more time is required due to the necessity to shift prepared merchandise to make room for various sub-processes, etc. Further, in order to maximize facility revenue, the amount of building area dedicated to merchandise preparation must be minimized in order to maximize the area dedicated to sales. Over time, as new stores have been built, old ones remodeled, and retail operations have become increasingly precise, department store MPA's have become extremely cramped facilities, such that their operations have become limiting factors in the overall efficiency of the stores.

Various solutions have been introduced to maximize the efficiency of MPA's. These have all been directed at increasing the density of merchandise which can be stored in a given amount of space on the floor of the MPA. Multiple level garment hangers, nested rolling garment racks, various floor or wall mounted shelving systems, are all in widespread use. However, the building volume above the floor of MPA's has not been successfully exploited to increase the efficiency of these facilities. Dry-cleaning-type garment conveyors, and other devices, have been tried but found to be not useful or cost-effective. Department stores typically have vertical floor-to-floor dimensions over 17 ft., providing a large amount of volume that can be used, effectively up to doubling the useful volume of the MPA. Accordingly, there is a need for an improved system for processing incoming merchandise, particularly including a system that can take advantage of the vertical volume in the MPA.

### SUMMARY OF THE INVENTION

The present invention uses electromechanical technology to effectively use the available overhead space in an MPA. This is accomplished by an arrangement and configuration of machinery and controls that vertically raise and lower merchandise, especially garments, to and from the volume above the MPA floor. Merchandise is thus temporarily stored in this volume, allowing the existing floor area of the MPA to be effectively used to prepare additional merchandise, increasing the overall capacity of the MPA.

In a preferred form, the machinery used to operate this invention is suspended from overhead building structure in order to avoid using the existing floor area of the MPA. Motorized rigging apparatus, including electrical winch motors, gearboxes, line shafts, cable drums, flexible wire rope (aircraft cable), associated attachment hardware, and arrangements of pipe, are mounted to overhead building structure and used to lift and lower merchandise safely into and out of the available space above the floor. Merchandise is affixed temporarily to the pipes and lifted and lowered into and out of the space above. Control is provided by wired or wireless devices with appropriate buttons for moving the pipes up and down.

Benefits of the invention include reduced time to unload trucks and concomitant reduction in shipping costs; reduction in after-hours staff time required (since more can be accomplished during the working day), reduced labor costs; and increased efficiency of normal daily operations due to the increase in available floor area for temporary placement and through-travel of rolling garment and merchandise racks, portable equipment, and personnel. Multiple units can be provided, configured and sized in specific relation to the facility in which they are installed, to increase the benefits. Further advantages will become apparent from consideration of the drawings, description, and alternate embodiments in greater detail below.

### BRIEF DESCRIPTION OF THE DRAWINGS

The preferred and alternative embodiments of the present invention are described in detail below with reference to the following drawings.

FIG. 1 is a section view through a merchandise preparation area, showing a frontal view of a preferred hoisting system;

FIG. 2 is a perspective view of a preferred batten assembly for use with a hoisting system;

FIG. 3 is a perspective view of a preferred motor and gearbox shown driving a line shaft;

FIG. 4 is a bottom view of a preferred hoisting system;

FIG. 5 is a perspective view of an alternate hoisting system

FIG. 6 is a block diagram of a control system for operating a preferred hoisting system; and

FIG. 7 is a perspective view of a preferred alarm and safety sensing system incorporated into a batten.

### DETAILED DESCRIPTION OF THE PREFERRED EMBODIMENT

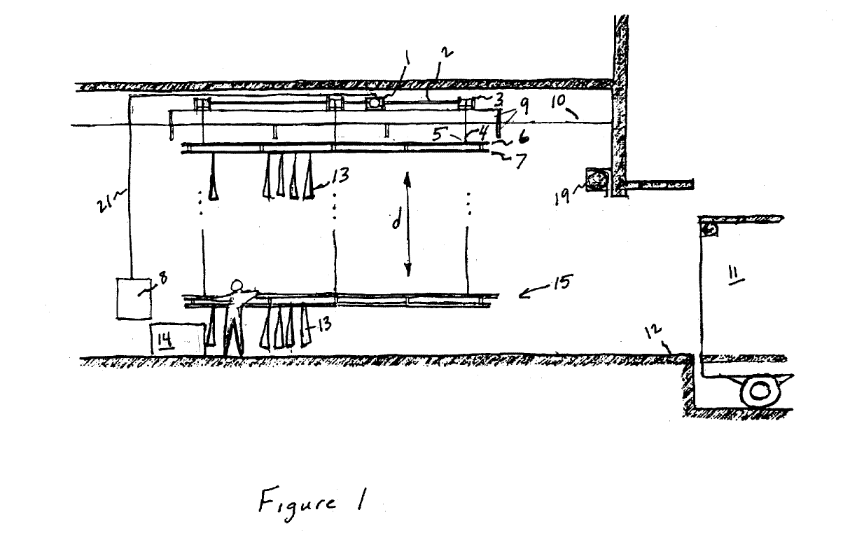

FIG. 1 illustrates a preferred hoisting system shown in operation in a merchandise preparation area having a loading dock 12. Typically, a truck 11 full of merchandise backs-up to the loading dock, a rolling door 19 is opened, and the goods are unloaded. Likewise, a variety of equipment 14 or other items may be stored on the floor, taking up valuable space. In this embodiment, the system is installed in a merchandise preparation area having a high ceiling with structural members 10 such as steel beams, joists, or other such members. One of the key aspects of the preferred form of the invention is that nearly the entire system is mounted to the overhead support structure so that the battens may be raised and lowered without consuming any floor space. Accordingly, the key components such as the motor and gearbox 1 and cable drums 3 are mounted to support beams 9 that are attached to one or more upper joists 10.

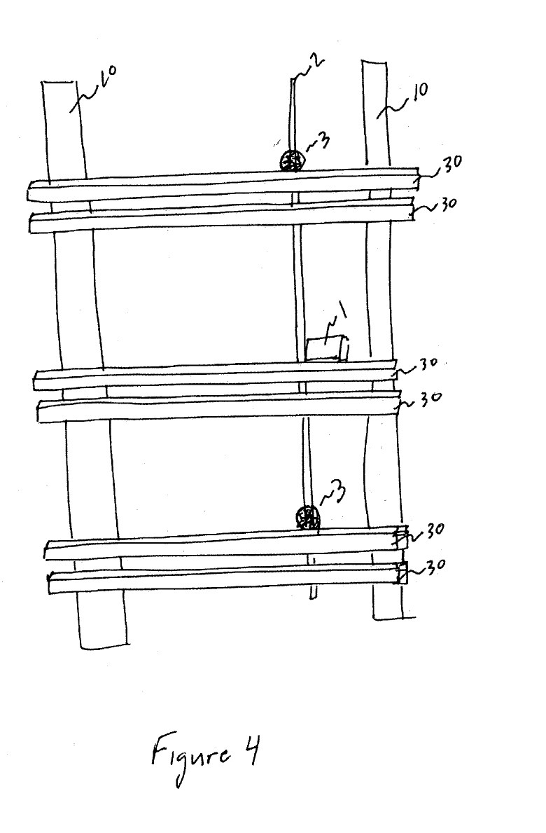

FIG. 4 illustrates a preferred mounting system. For simplicity, not all of the components of the invention are shown. A plurality of trusses 30 are mounted to I-beams 10 spanning the ceiling. As shown in FIG. 4, six trusses 30 are used, though a smaller or larger number of trusses can alternatively be used, as desired. Likewise, the trusses are shown as three pairs of two trusses spanning the I-beams. Individual trusses may alternatively be used, rather than pairs of smaller trusses. By spanning trusses across pairs of I-beams 10 (or other structural supports, depending on the particular building), the system provides a platform for the motor and other components of the invention to be mounted in the ceiling overhead area.

Returning to FIG. 1, the motor and gearbox 1 provide the force necessary to raise and lower the battens. The motor and gearbox are powered and controlled via a wall-mounted control panel 8, with one or more wires 21 enclosed in a conduit and extending from the control panel to the motor and gearbox 1 to carry electricity and control signals. Under the control of the control panel, the motor and gearbox 1 causes the battens to raise and lower as desired.

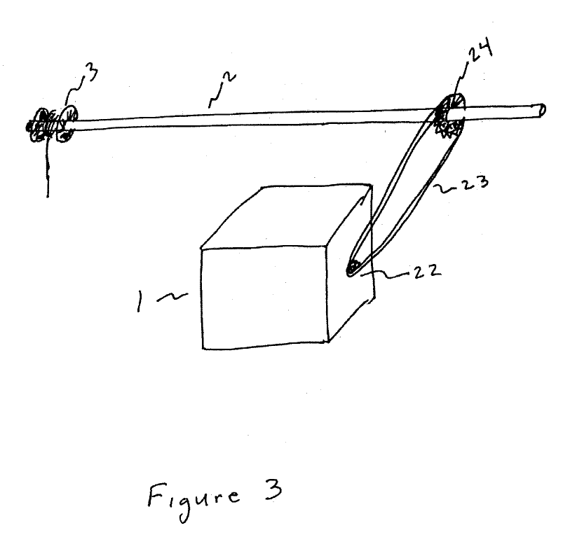

A line shaft 2 is connected to the motor and gearbox 1 and configured for rotation in either radial direction. The line shaft 2 is preferably a steel shaft capable of withstanding the torque necessary to raise and lower the battens when carrying a relatively heavy load. In the preferred form, the line shaft is a single steel member located adjacent the motor and gearbox 1 and driven by a roller chain. As best seen in FIG. 3, a roller chain sprocket is attached to the gearbox output shaft 22. Likewise, the line shaft 2 includes a roller chain sprocket 24. A roller chain 23 is trained around the crank shaft gear and line shaft gear such that rotation of the crank shaft causes rotation of the line shaft. One or more rotary limit switches (not shown) are also attached to the line shaft by roller chain. The limit switches are calibrated to send signals to the motor, instructing the motor to stop at the top and bottom travel limits.

It should be appreciated that there are many ways to accomplish the raising and lowering of the battens other than the particular construction illustrated in FIG. 3. For example, the crank shaft of the motor and gearbox 1 may itself serve as the line shaft. Alternatively, there may be more than one motor and gearbox, or the motor and gearbox may be located at one of the ends of the line shaft, rather than in a central location.

The line shaft 2 is operatively connected to three cable drums 3, including one at each end of the shaft and one generally in the center. Accordingly, rotation of the line shaft causes a corresponding rotation of each of the cable drums 3. The number of cables and cable drums is determined by the desired load capacity, maximum lifting and lowering speed, and stability requirements of the particular location. Accordingly, any number of these components may be used. The cable drums 3 are mounted via pillow block bearings on the trusses 30 extending across ceiling I-beams 10, as shown in FIG. 4. The cable drums 3 are grooved internally to facilitate the winding of the cable 4 used to raise and lower the battens. While cables are preferred, chain, rope, or other materials may also be used in place of the cables.

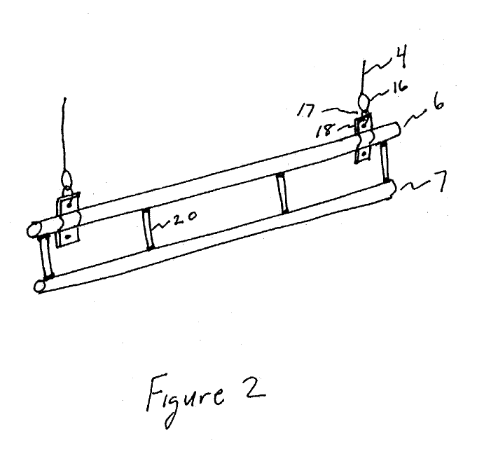

One end of a length of cable 4 is attached to each of the cable drums 3. Preferably the cable comprises a multi-strand aircraft cable to provide strength. The opposite end of each of the lengths of cable is attached to a main batten 6 using hardware 5 such as thimbles, wire rope clips, turnbuckles, or other components as determined by size and desired capacity of unit. As illustrated in FIG. 2, the cable 4 is attached to a turnbuckle 16 which, in turn, is attached to karabiner 17. The karabiner is attached to a pair of mounting plates 18 that are bolted about the main batten 6.

The main batten 6 is constructed from standard schedule 40 or schedule 80 steel pipe. In one embodiment, the main batten is used without any additional battens and is configured to allow garments to be hung directly on it. In the preferred form, however, a garment batten 7 is attached to and suspended below the main batten 6. The garment batten 7 is a steel pipe having a one inch diameter to enable any number of garments 13 to be hung on the batten via standard garment hangers. Several steel plate tabs 20, each two inches in length, are welded to the main batten and to the garment batten to fasten the two battens together. Once joined together in this fashion, the garment batten is two inches below and parallel to the main batten. Alternative methods can be used to join the battens together. For example, cables, chains, or steel rods can be used.

The batten is a substantially long rod or pipe, capable of carrying a large volume of garments or other articles. In addition, it is raised directly vertically, unlike typical dry-cleaning suspension systems, so that it can maintain the entire batten off the floor for storage and allows retrieval of a large quantity of articles at the same time.

In an alternate embodiment, an additional “marry batten” can be suspended below the main batten 6. Either the garment batten or marry batten can be collectively referred to as a secondary batten. The marry batten (not shown) is suspended below the main batten with enough vertical clearance between the main batten and the marry batten to allow garments to be hung on the main batten. The marry batten is attached to the main batten using karabiner clips or other suitable hardware and steel cables. In this form, the marry batten is essentially the same as the garment batten 7, but is suspended approximately five feet below the main batten rather than two inches below the main batten as in the preferred embodiment. This alternative embodiment effectively doubles the capacity of the system by allowing two rows of garments to be hung, one above the other, then raised to the ceiling.

The wall-mounted control system 8 includes appropriate switches to cause the battens to be raised or lowered, as desired. Thus, in operation, the motor 1 causes the batten to raise toward the ceiling or to lower a distance d toward a lowered position 15 where articles can be retrieved by workers on the floor. In some embodiments, multiple systems (each having separate motors, battens, etc.) may be installed in a single merchandise preparation area. In such an embodiment, the control system includes appropriate -controls to separately activate separate batten systems. Additional features such as indicator lights and emergency stop buttons are also provided.

In some embodiments, the system can be operated by a wireless control unit. A handheld transmitter having a plurality of buttons or switches is programmed to send control signals to a receiver. The receiver can be located adjacent the ceiling with the other hardware, or can be mounted in the wall-mounted control panel. Such a system allows an operator to control the raising and lowering of battens without physically walking to the control panel.

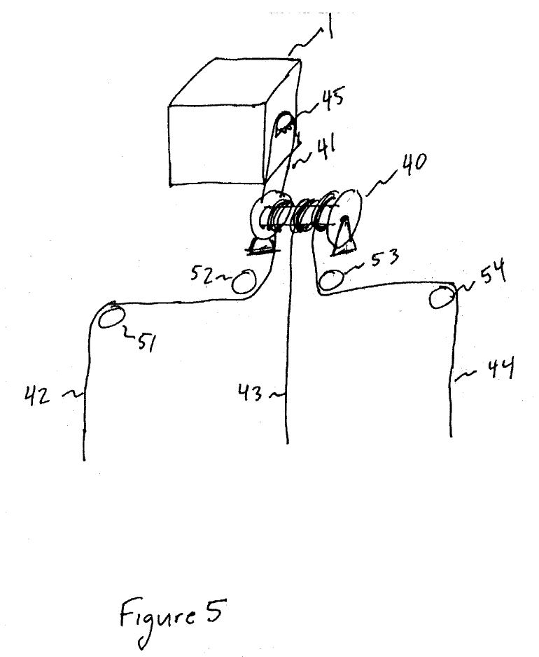

The system for raising and lowering the merchandise may be accomplished using any of a variety of alternative structures. For example, FIG. 5 illustrates an alternative embodiment in which no line shaft is used. In this embodiment, the motor 1 includes a roller chain 41 trained around a crank shaft gear 45 and a gear (not shown) configured to rotate a cable drum 40. In this fashion, the motor operates the rotation of the drum directly, rather than through a line shaft.

The cable drum 40 includes three separate cables 42-44, each wound around the drum in separate sections. A first cable 42 has one end attached to the drum, with the opposite end extending outward from the drum. The first cable is then trained around one or more sheaves or blocks 51, 52 to direct the first cable away from the drum and toward the main batten from a desired angle. The second cable 43 is centrally located in this embodiment, and extends directly downward to the main batten. Finally, the third cable 44 includes one end that is trained around a pair of blocks 53, 54 and on to the main batten.

Any number of cables (e.g., fewer or greater than three) can be wound around an appropriately-sized cable drum in order to raise and lower a batten or other merchandise-carrying load. The number and type of cables used in any of the above embodiments should be chosen to provide appropriate balance of the load and strength for safety based on the expected weight and speed at which the load will be raised and lowered. In addition, by using sheaves, the cables can be directed around any building structures that are in a direct path between the motor and the load. Similarly, such an arrangement allows the motor to raise and lower a batten having any shape other than a single straight pipe. For example, an L-shaped, circular, or rectangular merchandise-carrying batten could also be used.

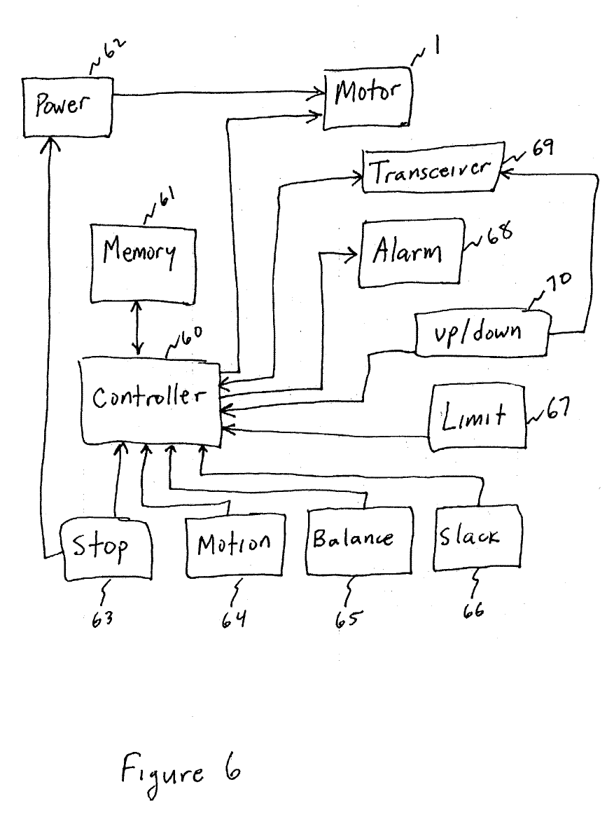

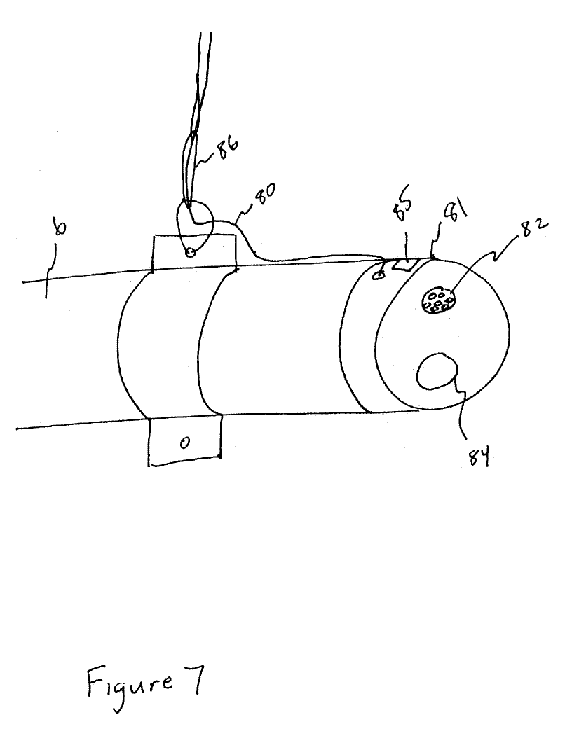

The merchandise hoisting system preferably includes a number of safety features. Many of these features are illustrated in FIG. 6, which shows them as they interact with a preferred control system, and FIG. 7, which illustrates them incorporated into a batten. The control system includes a controller 60, which preferably includes a microprocessor capable of operating programming instructions stored in an associated memory 61 to control the operation of the system and its safety features.

In a wireless remote application, basic instructions to raise, lower, and stop operation of the motor 1 are provided to the controller via a hand-held remote (not shown in FIG. 6) that sends signals to a transceiver 69. The transceiver passes received commands to the controller, which interprets the commands and causes the applicable subsystem to carry them out. In some embodiments, the transceiver 69 wirelessly passes commands from the controller to other subsystems. Although the subsystems such as the motor, sensors, and alarms are all shown as being in wired signal communication with the controller 60, each of them may communicate with the controller wirelessly. This could be accomplished via the transceiver 69 or via additional transceivers (not shown).

In basic operation, the movement of the batten is accomplished by issuing primary up, down, or stop commands via a wall-mounted or hand-held unit 70. As shown in FIG. 6, the commands may be issued directly to the controller 60, or wirelessly through the transceiver 69. The controller, in turn, causes the motor to turn in a desired direction or to stop, as appropriate.

A number of safety features are also incorporated into the embodiment shown in FIG. 6. A limit switch 67 signals to the controller that the batten has been raised or lowered to its preset limits. Although shown in FIG. 6 as being in communication with the controller 60, the limit switch may also communicate directly with the motor to cause the motor to stop.

An emergency stop button 63 is provided to immediately stop all movement of the motor. The emergency stop 63 is connected directly to the power source 62 (e.g., the circuit breaker) and may also be connected in parallel to the controller. In this fashion, the power is cut both at the power supply and also by the controller issuing a stop command in the same fashion as an ordinary operation stop command.

In addition to the emergency stop, alarms 68 are provided to signal to those in the area that the batten is being raised or lowered. In one embodiment, visual and audible alarms are provided on one or both ends of the batten 6, as shown in FIG. 7. In the form shown, an end cap 81 is attached to the batten 6, with the end cap containing sensors and alarms. The devices within the end cap may be powered by and communicate with the controller 60 via one or more wires 80 running from the controller 60 to the end cap, or may be battery powered and include a transceiver 85 for wireless communication. In the wireless embodiment, an internal microprocessor is also provided (not shown) to interpret commands to trigger alarms and send sensor data to the controller.

A speaker 82 is provided in the end cap 81 to provide an audible “beep” or other alarm when the batten is in motion. Thus, the controller receives a signal from a motion detector 64 within the end cap (or from any alternative source, such as the motor or cable drum) and causes the alarm 68 to sound audibly through the speaker 82. In addition, a light 84 is attached to the outside of the end cap to flash or otherwise visibly indicate that the batten 6 is in motion. Additional audible and visible alarms can be triggered on other conditions, such as a slack line or load imbalance.

A load balance sensor 65 is also provided within the end cap and configured for communication with the controller 60. The load balance sensor can be accomplished in a variety of ways. It may comprise weight or force sensors at each end of the batten. In this form, the controller 60 will continually monitor the weight at each sensor to determine whether the load is relatively evenly distributed. If the load is substantially unbalanced, particularly if established tolerances indicate that too much weight is placed on one end, an applicable alarm will sound and the controller will prevent the motor from raising the load until the condition is corrected.

A slack line detector 66 is also provided. The slack detector may be accomplished in a variety of ways. For example, a sensor may be located in close proximity to a lift cable 4, at a suitable vertical position close to its associated drum or sheave, such that a lateral displacement of the cable caused by removal of tension (load) on the cable triggers the sensor. Assuming that multiple cables are provided to carry the load, the batten should be level unless there is slack in one of the lines. Alternatively, a tension sensor 86 may be placed in-line with the cables to detect the tension in the line. If the tension sensor 86 detects little or no force on one or both sides of the batten, the controller 60 will cause an appropriate alarm to sound.

In yet another alternative embodiment, most of the sensors and alarms can be self-contained within the batten end cap, rather than interacting with the controller 60. Thus, an internal end cap processor can resolve the signals received by the sensors and cause applicable alarms to sound. In addition, the alarms and sensors can be provided in many alternative ways other than in a batten end cap. For example, they can be incorporated into the cables, can be placed on overhead structure, or can be placed in intermediate locations along the batten.

While the preferred embodiment of the invention has been illustrated and described, as noted above, many changes can be made without departing from the spirit and scope of the invention. In addition, the system is not intended to be limited strictly to merchandise or particular garments. For example, it may be equally useful to store garments in settings other than retail or wholesale clothing stores. Similarly, it may be useful for storing merchandise other than garments, particularly when such merchandise can be suspended from a batten as with clothing. Accordingly, the scope of the invention is not limited by the disclosure of the preferred embodiment.

The embodiments of the invention in which an exclusive property or privilege is claimed are defined as follows:

1. A merchandise hoisting system for use in a building having a floor and a ceiling in order to raise merchandise above the floor, the system comprising:
a motor;
a line shaft coupled to the motor and configured for rotation under control of the motor; and
a main batten operatively secured to the line shaft such that when the motor causes the line shaft to rotate in a first direction the main batten is raised and when the motor causes the shaft to rotate in a second direction the main batten is lowered.

2. The merchandise hoisting system of claim 1, further comprising:
a cable drum attached to the line shaft, and
a length of cable having a first end and a second end, the first end of the cable being attached to the cable drum and the second end of the cable being attached to the main batten.

3. The merchandise hoisting system of claim 1, further comprising:
a plurality of cable drums attached to the line shaft, and
a plurality of cables, each of the plurality of cables having a first end and a second end, wherein the first end of each one of the plurality of cables is attached to a different one of the plurality of cable drums and the second end of each of the plurality of cables is attached to the main batten.

4. The merchandise hoisting system of claim 3, further comprising a secondary batten attached to and suspended below the main batten, and wherein the merchandise comprises garments.

5. The merchandise hoisting system of claim 4, wherein the secondary batten is suspended below the main batten by a distance of approximately two inches.

6. The merchandise hoisting system of claim 4, wherein the secondary batten is suspended below the main batten a sufficient distance such that clothing may be hung on the main batten without the clothing contacting the secondary batten.

7. The merchandise hoisting system of claim 4, wherein the secondary batten comprises a metal pipe having a diameter of approximately one inch.

8. The merchandise hoisting system of claim 7, wherein the motor and cable drums are attached to structural support members adjacent the ceiling.

9. The merchandise hoisting system of claim 7, wherein the entire system is suspended above the floor.

10. The merchandise hoisting system of claim 9, further comprising a controller operable by user to cause the motor to raise or lower the batten.

11. The merchandise hoisting system of claim 4, further comprising at least one sensor operatively configured to detect a condition of the batten, and an alarm to indicate a condition of the batten.

12. The merchandise hoisting system of claim 11, wherein the at least one sensor comprises a motion sensor and a slack line sensor, and where the alarm further comprises an audible alarm and a visible alarm attached to the batten.

13. A garment hoisting system for use in a building having a floor and a ceiling in order to raise garments above the floor, the system comprising:
a means for supporting a plurality of garments, each of the garments being attached to a garment hanger; and
a means for raising the supporting means for storage adjacent the ceiling and for lowering the supporting means to a working position adjacent the floor.

14. The garment hoisting system of claim 13, wherein the raising means comprises a motor, a line shaft coupled to the motor and configured for rotation under control of the motor, and a cable from the line shaft to the supporting means.

15. The garment hoisting system of claim 14, wherein the supporting means comprises a main batten operatively secured to the line shaft such that when the motor causes the line shaft to rotate in a first direction the main batten is raised and when the motor causes the shaft to rotate in a second direction the main batten is lowered.

16. The garment hoisting system of claim 13, wherein the raising means comprises a motor and a plurality of cables operatively connected to the motor and the supporting means.

17. A method for hoisting garments above a floor for storage, comprising:
attaching the garments to a batten; and
operating a motor coupled to the batten to cause the garments to be raised above the floor.

18. The method of claim 17, wherein the batten comprises a substantially horizontal pipe or rod configured to support a plurality of garments attached to garment hangers.

19. The method of claim 18, wherein operating the motor causes the batten to be raised in a vertical direction.
